(19) United States
(12) Patent Application Publication
(10) Pub. No.: US 2010/0135756 A1
(43) Pub. Date: Jun. 3, 2010

(54) SYSTEM FOR LIFTING AND STOWING A VEHICLE

(75) Inventor: Amos G. Winter, IV, Concord, NH (US)

Correspondence Address: Vern Maine & Associates, 100 MAIN STREET, P O BOX 3445, NASHUA, NH, 03061-3445, US

(73) Assignee: APPROPRIATE COMBINED TECHNOLOGIES, LLC, Santa Clara, CA (US)

(21) Appl. No.: 12/629,498

(22) Filed: Dec. 2, 2009

Related U.S. Application Data
(60) Provisional application No. 61/119,083, filed on Dec. 2, 2008.

(51) Int. Cl. B60R 9/06

(52) U.S. Cl. 414/462; 414/680

(57) ABSTRACT

A vehicle lifting and stowing “VLS” system compactly stores a vehicle by lifting and tilting it vertically. The VLS can be attached to a fixed structure for compactly storing a vehicle, or mounted to the aft end of a host vehicle, such as a motor home, for vertically mounting and transporting a smaller vehicle with the host vehicle. The VLS includes a main frame and two rotatable extensions hingedly joined end-to-end. The first extension is rotated by a drive mechanism while the second section maintains attachment to the vehicle, thereby lifting first one end of the vehicle and then the entire vehicle above grade. Some embodiments also include a pulling strap. Positioning of the vehicle above the extensions can automatically cause the second extension to contact and attach to the vehicle. Embodiments include alignment and/or support pins. Some embodiments include latches that hold the extensions together in the stowed configuration.

### RELATED APPLICATIONS

This application claims the benefit of U.S. Provisional Application No. 61/119,083, filed Dec. 2, 2008, incorporated herein by reference in its entirety for all purposes.

### FIELD OF THE INVENTION

The invention relates to vehicle lifting and storage apparatus, and more particularly to apparatus for storing a vehicle in a limited space.

### BACKGROUND OF THE INVENTION

Many systems are known for lifting and stowing vehicles of all types, whether for storage, parking or transport. A general purpose, primary vehicle may include a towing “hitch” to which a secondary vehicle can be attached for towing. For example, a recreational vehicle may include a hitch for towing a smaller passenger vehicle. In addition, some tow trucks lift one end of a vehicle and then pull the vehicle behind them. However, a large, general purpose vehicle towing a secondary vehicle can be inconvenient and difficult to drive and maneuver, due to the extended length of the pair of vehicles.

Specialized tow trucks use a variety of methods for transporting individual vehicles on top of their structures. Some tow trucks include a flat bed that can be tilted to form a ramp up which a vehicle can be pulled, and then transport the vehicle on top of the flat bed. Special car-hauling trucks typically include a multi-story structure with ramps onto which vehicles can be driven, so as to simultaneously transport a plurality of vehicles arranged on a plurality of vertical levels on top of the truck. Some recreational vehicles even have drive-on vehicle storage space. However, such specialized vehicles are expensive, and their usefulness for other purposes is substantially limited by the need to provide dedicated space for transporting a secondary vehicle.

Parking structures use various methods to elevate vehicles and position them vertically above each other. In many cases, a parking structure uses a series of ramps to allow vehicles to drive to upper levels. When space is more limited, elevators are sometimes used to lift vehicles to elevated parking platforms. Overhead cables and slings are also known for lifting and re-positioning vehicles vertically. However, all of these approaches require specially designed and expensive multi-level structures.

What is needed, therefore, is an apparatus for storing and/or transporting a vehicle in a limited space, without requiring a specialized, multi-level storage structure.

### SUMMARY OF THE INVENTION

A vehicle lifting and stowing (“VLS”) system is claimed that can store and/or transport a vehicle in a limited space without requiring placement of the vehicle in a multi-level structure. The claimed VLS is attachable an end or undercarriage of a vehicle, and is able to lift the vehicle while tilting it by 90 degrees, so as to store the vehicle in a vertical configuration, thereby taking advantage of the fact that the height of most vehicles is much less than the length thereof.

In some embodiments, the VLS is mountable to the end of a host vehicle, such as a truck, recreational vehicle, or camper, whereby a secondary vehicle, such as a small car or golf cart, can be lifted above grade into a vertical orientation and brought into close proximity to the aft end of the host vehicle for transport. In some of these embodiments, the VLS mechanism has principle points of attachment to the host vehicle which in some embodiments may be at or near the aft ends of the frame rails running lengthwise of the chassis.

In other embodiments, the VLS system can be affixed to a stationary structure, so as to provide vehicle storage in a limited space. In some of these embodiments, the stationary structure includes vertical lift and/or rotational capabilities that provide for unloading a vehicle from the VLS at a location displaced vertically and/or rotationally from the loading location. For example, in a parking lot with limited space, some stationary VLS embodiments are able to load a vehicle into a storage configuration from a designated entrance ramp, rotate the base station 180 degrees while the vehicle is stowed, and then re-deploy the vehicle on a separate exit ramp.

In various embodiments, the VLS includes a double-jointed mechanism with a main frame, an elongated second section, and an elongated third section. The main frame is attached or attachable to a stationary structure or to one end of a host vehicle chassis, or to some other suitable support structure or platform provided by the host vehicle. The second section is hingedly attached by one end to the main frame and is rotational with respect to the main frame between an upwardly extending vertical (stowed) position and an outward or aft-extending horizontal (loading) position. The third section is hingedly attached to the other end of the second section, and is rotatable through about 180 degrees from an aft-extending horizontal (loading) orientation, when the second section is also horizontal, to a downward-extending vertical (stowed) orientation when the section is also vertical, whereby the third section is folded back onto the second section.

In various embodiments, the mechanism is so designed that the second and third sections rotate concurrently in opposite directions, the second section through about 90 degrees with respect to the main frame as the third section rotates through about 180 degrees in the opposite direction with respect to the main section. The resulting motion of the third section with respect to the main frame is a lifting along an inward arc towards the stowed position, concurrently with an outwardly rotating motion from horizontal to vertical.

When the VLS mechanism is fully extended in the loading position, a vehicle can be maneuvered into position whereby it straddles the extended second and third sections. The underside of the vehicle is configured for locking engagement or attachment to the third section. The locking action for securing the engagement may be a function of the engaging motion, or the lifting motion, or may be separately activated after full engagement.

Once the vehicle is properly engaged with or attached to the third section, the VLS is activated for lifting and stowing the vehicle. As the double-jointed mechanism formed by the second and third sections rotates into the stowed orientation, the vehicle is rotated by 90 degrees from horizontal to vertical, while it is lifted upward and inward so that the undercarriage of the vehicle is brought into close proximity with the main frame of the VLS. In various embodiments, once the mechanism is in the fully stowed vertical orientation, the second and third sections are mechanically locked in position with respect to the main frame. In some embodiments, the vehicle may be further secured in the stowed position by locking pins extending from the third section of the VLS into the underside of the vehicle at points displaced from the initial point of attachment. The vehicle is thus secured to the VLS mechanism, which is in turn locked in the stowed position. If the VLS is attached to the aft end of a host vehicle, this places the stowed vehicle in a vertical orientation above grade and directly behind the host vehicle, so as to be transportable by the host vehicle without encroaching on the space enclosed by the host vehicle, and with minimal extension to the effective length of the host vehicle.

In various embodiments, the VLS mechanism may be powered by any combination of electrical, hydraulic, and/or manual means, utilizing simple or elaborate control systems. Push rods or cables, separately or in combination, may be used to rotate the VLS system between its loading and stowed positions, which may also be called its extended and retracted positions, respectively. Power for operating the VLS system, which may include any or all of electrical, hydraulic, and mechanical power, can be provided by the host vehicle, by the VLS mechanism, or by an external source.

So as to be compatible with storage by the claimed VLS mechanism, all vehicle subsystems must able to function normally after the vehicle has been rotated to a vertical orientation and then returned to a normal, horizontal orientation. In addition, for embodiments where the VLS is attached to a host vehicle, the stowed vehicle length must be short enough so as to fit below highway overpasses and not extend above the maximum allowed vehicle height when elevated off the ground vertically on the aft end of the host vehicle. The underside of the stowed vehicle may be manufactured with a suitable latching mechanism for engagement to the third member of the VLS, or it may be modified or adapted for the VLS system by an aftermarket kit. Some embodiments provide a plurality of latching mechanisms, thereby enabling selection of a suitable latching mechanism for each vehicle to be stowed.

One general aspect of the present invention is a system for lifting and stowing a stowable vehicle. The system includes a main frame, a rigid first extension having a first extension proximal end and a first extension distal end, the first extension proximal end being hingedly attached to the main frame so as to enable the first extension to rotate between a substantially horizontal configuration in close proximity to grade and a substantially vertical configuration, a rigid second extension having a second extension proximal end hingedly attached to the first extension distal end, the second extension being attachable to the stowable vehicle, and a drive mechanism configured so as to apply a rotational torque to the first extension, thereby transitioning the first extension between the substantially horizontal configuration and the substantially vertical orientation, and transitioning the stowable vehicle between a horizontally deployed configuration on grade and a vertically stowed configuration above grade.

In some embodiments, the main frame is fixable to an immovable support. In other embodiments, the main frame is mountable to a host vehicle. In certain embodiments, the main frame is mountable to an aft end of a host vehicle, so as to enable vertical stowing of the stowable vehicle above grade and in close proximity to the aft end of the host vehicle.

In various embodiments, the second extension extends horizontally beyond the first extension when the first extension is in the substantially horizontal configuration. Some of these embodiments further include a latch configured so as to latch the second extension in vertical proximity to the first extension when the first extension is in the substantially vertical configuration.

In certain embodiments, the second extension folds horizontally above and parallel to the first extension when the first extension is in the substantially horizontal configuration. Some of these embodiments include a flexible member extending from the main frame to the second extension and able to apply a pulling force thereto as the first extension is rotated from the substantially horizontal configuration to the substantially vertical configuration. And some of these embodiments include at least one pulley configured so as to support the flexible member and avoid contact between the flexible member and the stowable vehicle.

In various embodiments the second extension distal end is attachable to the front of the stowable vehicle, the rear of the stowable vehicle, and/or the undercarriage of the stowable vehicle.

In certain embodiments, the drive mechanism includes at least one hydraulically driven piston. In other embodiments, the drive mechanism includes at least one electrically driven motor. And in yet other embodiments, the drive mechanism can be manually powered.

In some embodiments, the second extension is attachable to the stowable vehicle by insertion of a tongue into a corresponding receptacle.

Various embodiments further include at least one alignment pin attached to the second extension and insertable into an alignment hole provided on the undercarriage of the stowable vehicle so as to at maintain alignment of the stowable vehicle with the second extension.

Other embodiments further include at least one support pin attached to the second extension and insertable into a support hole provided on the undercarriage of the stowable vehicle so as to at least partially support of the weight of the stowable vehicle when the stowable vehicle is in the vertically stowed configuration. And in some of these embodiments the support pin includes a pin latching mechanism configured to inhibit unintentional dislodgement of the support pin from the support hole.

And various embodiments further include a switch that is activatable by positioning of the stowable vehicle above the first extension so as to cause the first extension to rotate, bringing the second extension into contact with the undercarriage of the stowable vehicle and thereby causing attachment of the second extension to the stowable vehicle.

A second general aspect of the present invention is a system for lifting and stowing a stowable vehicle. The system includes a main frame, a rigid first extension having a first extension proximal end and a first extension distal end, the first extension proximal end being hingedly attached to the main frame so as to enable the first extension to rotate between a substantially horizontal configuration in close proximity to grade and a substantially vertical configuration, a rigid second extension having a second extension proximal end hingedly attached to the first extension distal end so as to extend horizontally beyond the first extension in close proximity to grade when the first extension is in the substantially horizontal configuration, the second extension being attachable to the stowable vehicle, a drive mechanism configured so as to apply a rotational torque to the first extension near the first extension proximal end, thereby transitioning the first extension between the substantially horizontal configuration and the substantially vertical configuration, and consequently transitioning the second extension and the stowable vehicle between a horizontally deployed configuration on grade and a vertically stowed configuration above grade, a latch configured so as to latch the second extension in vertical proximity to the first extension when the first extension is in the substantially vertical configuration, and at least one support pin attached to the second extension and insertable into a support hole provided on the undercarriage of the stowable vehicle so as to align the stowable vehicle with the second extension and so as to at least partially support of the weight of the stowable vehicle when the stowable vehicle is in the vertically stowed configuration.

In various embodiments of this general aspect the main frame is mountable to an aft end of a host vehicle, so as to enable vertical stowing of the stowable vehicle above grade and in close proximity to the aft end of the host vehicle.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1A illustrates an embodiment in the horizontal orientation with a vehicle positioned for stowage;

FIG. 1B illustrates the embodiment of FIG. 1A with the second section slightly rotated so as to bring the proximal end of the third section into contact with the undercarriage of the vehicle;

FIG. 1C illustrates the embodiment of FIG. 1A in transition, with the rear wheels of the vehicle lifted above grade and the front wheels remaining on grade;

FIG. 1D illustrates the embodiment of FIG. 1A in transition, with both the front and rear wheels lifted above grade;

FIG. 1E illustrates the embodiment of FIG. 1A in the vertical orientation, with the vehicle lifted above grade in a vertically stowed configuration;

FIG. 2 illustrates the embodiment of FIG. 1E attached to the aft end of a recreational vehicle;

FIG. 3A is a detailed illustration of the second and third sections of the embodiment of FIG. 1A shown in the horizontal orientation without an attached vehicle;

FIG. 3B is a detailed illustration of the second and third sections of the embodiment of FIG. 3A shown in a transitional orientation;

FIG. 3C is a detailed illustration of the second and third sections of the embodiment of FIG. 3A shown in the vertical orientation;

FIG. 3D is a disassembled view of the second and third sections of the embodiment of FIG. 3A;

FIG. 4A is a disassembled view of a tongue-receiving attachment assembly mountable to the undercarriage of a vehicle;

FIG. 4B is an assembled view of the tongue-receiving attachment assembly of FIG. 4A;

FIG. 5A is a close-up view of the proximal end of the second section of the embodiment of FIG. 3A in the horizontal orientation;

FIG. 5B is a close-up view of the proximal end of the second section and the distal end of the third section of the embodiment of FIG. 3A in the vertical orientation;

FIG. 6A illustrates an embodiment that includes a pulling cable, shown in the horizontal configuration without an attached vehicle;

FIG. 6B illustrates the embodiment of FIG. 6A with a vehicle attached and ready for lifting;

FIG. 6C illustrates the embodiment of FIG. 6B in a transitional orientation, with the rear wheels of the vehicle lifted above grade and the front wheels remaining on grade; and

FIG. 6D illustrates the embodiment of FIG. 6B in the vertical orientation, with both the front and rear wheels of the vehicle lifted above grade.

### DETAILED DESCRIPTION

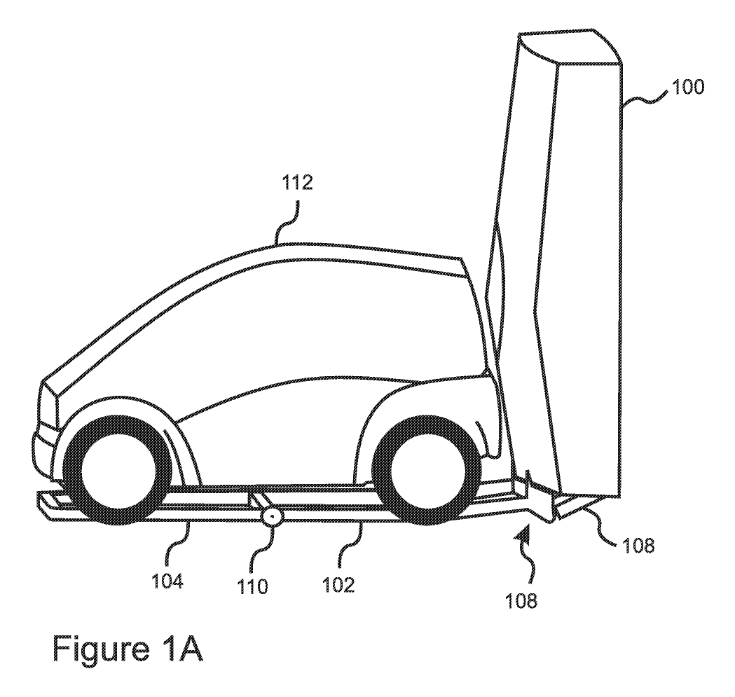

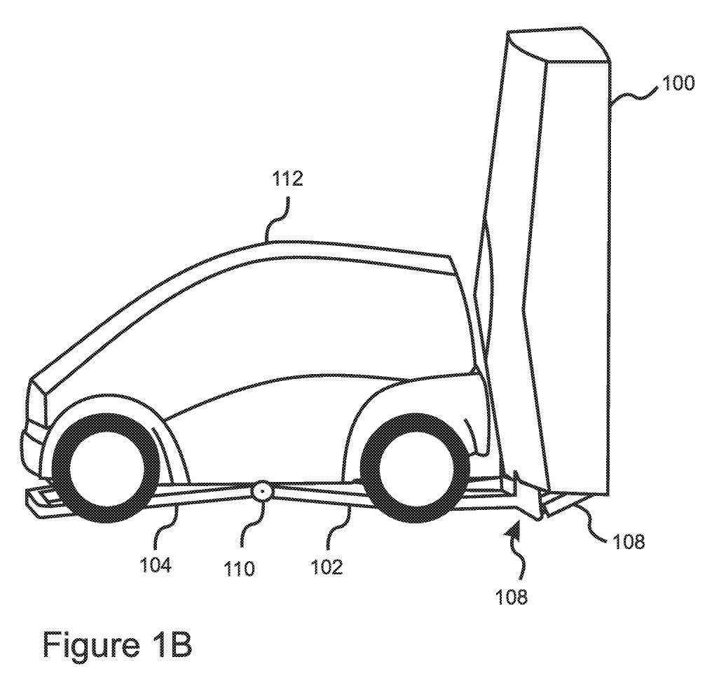

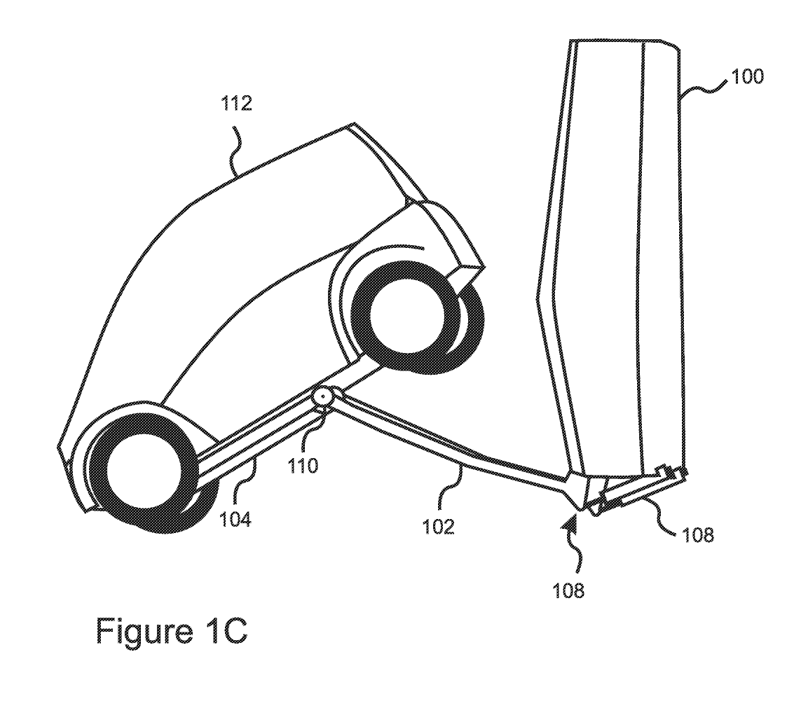

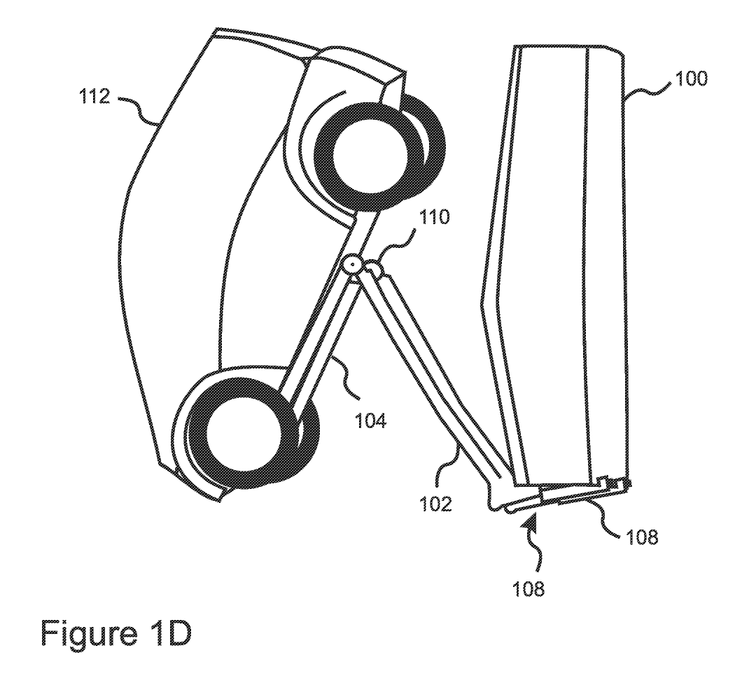

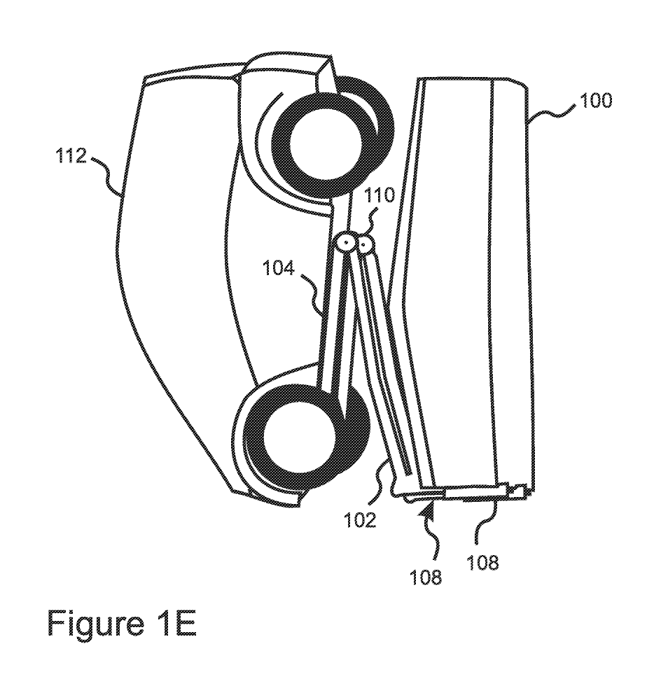

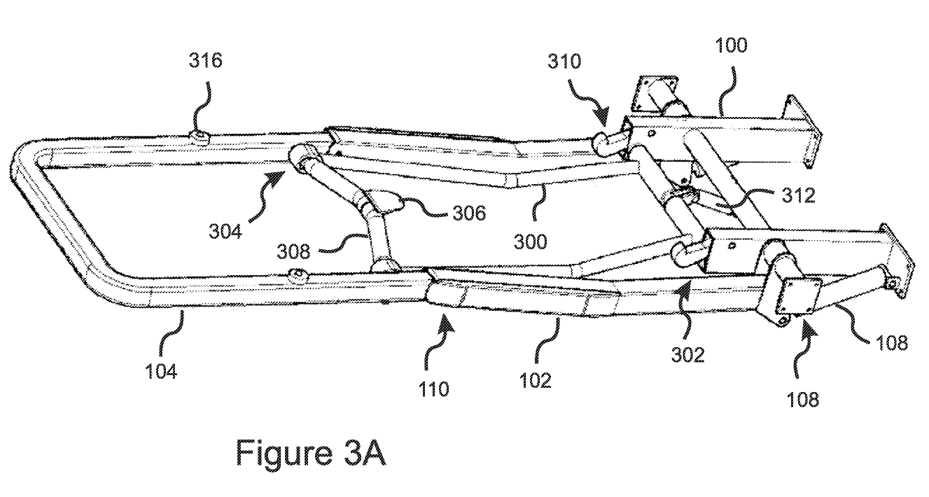

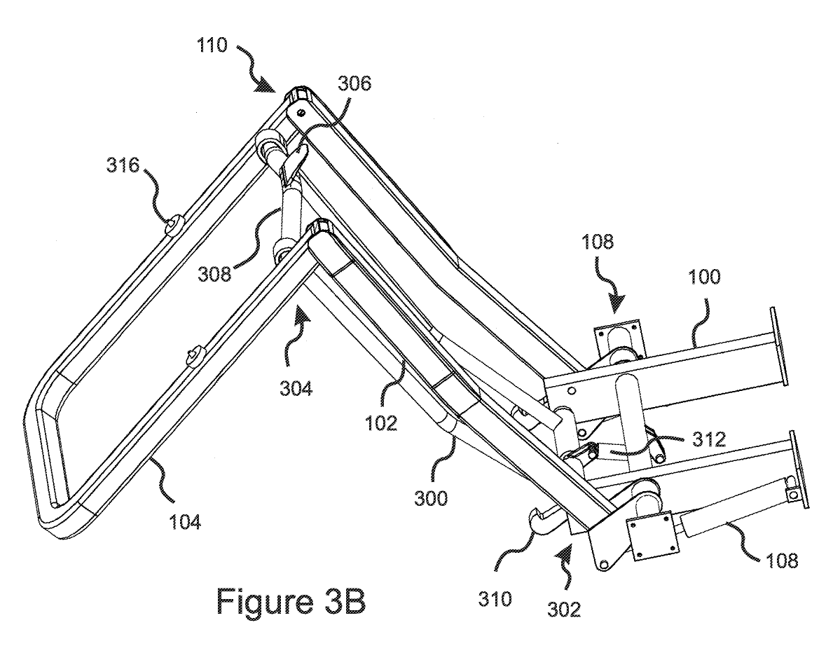

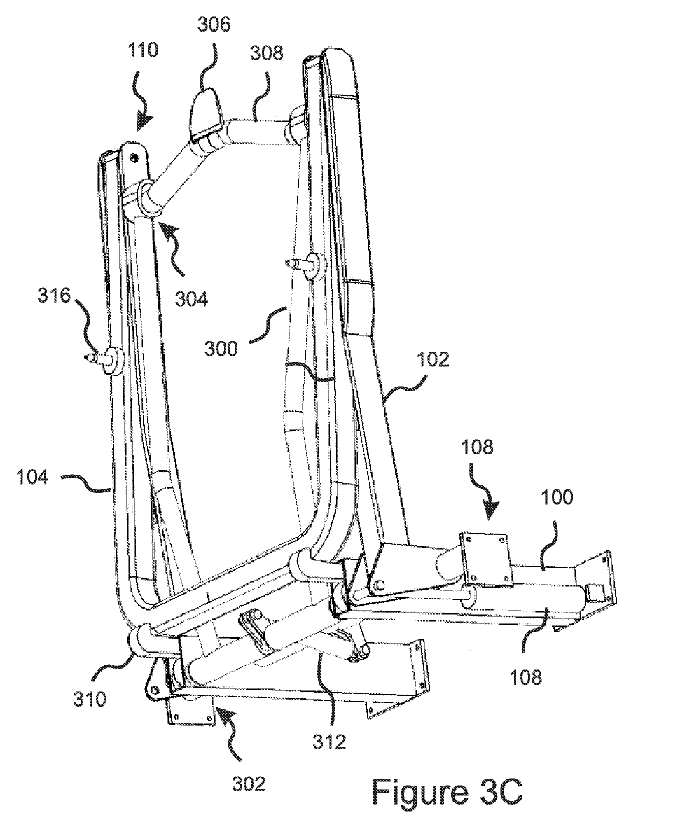

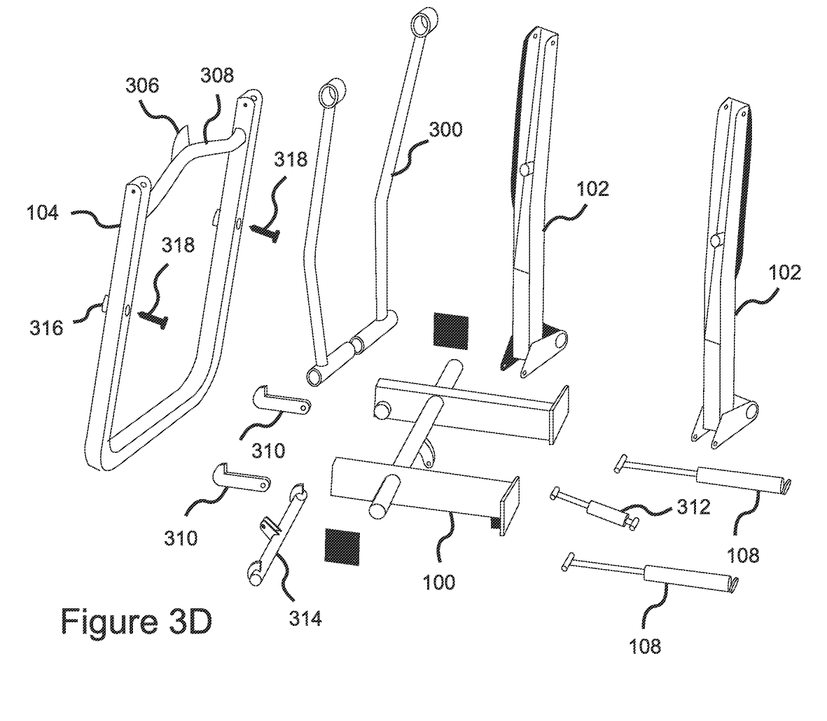

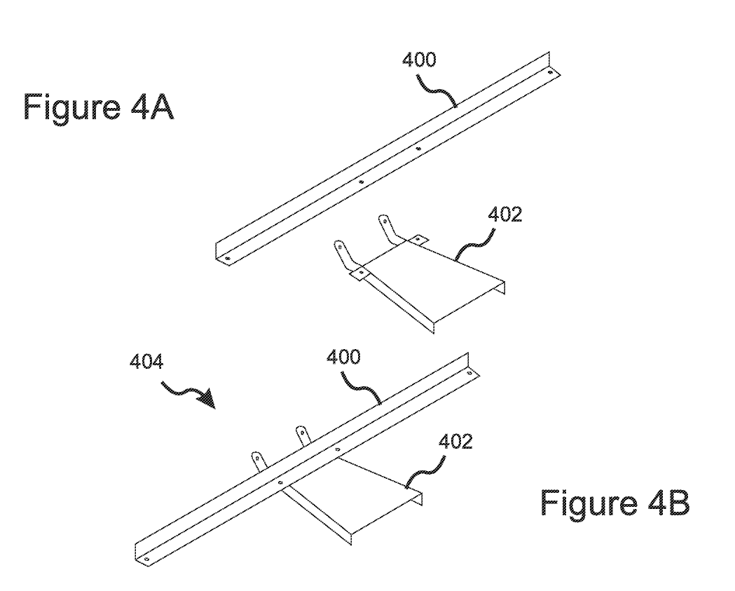

FIGS. 1A through 1E illustrate an embodiment of the present invention in a sequence of configurations as it moves a supported vehicle from a loading to a stowed configuration. With reference to FIG. 1A, the VLS of the present invention includes a main frame 100 from which extends a second section 102 and a third section 104. The main frame 100 is mounted either to a host vehicle, such as a class A or class C camper, or to a fixed structure. In either case, the main frame 100 is connected to the proximal end of the second section 102 by a first pivoting joint 106 which is rotatable in the embodiment of FIGS. 1A through 1E by a pair of hydraulic pistons 108. The distal end of the second section 102 is connected to the proximal end of the third section 104 by a second pivoting joint 110. The second section 102 and the third section 104 are illustrated in FIG. 1A in their extended, loading configuration, and a small passenger vehicle 112 is illustrated as being located above the second and third sections ready for attachment and stowing. The passenger vehicle 112, already configured with a receiver assembly (404 in FIG. 4B) on its underside, has been maneuvered towards the main frame 100, backing up in this case so as to straddle the extended second and third members 102, 104 and reach a mechanical stop (not shown). This assures that the vehicle 112 is in the correct position and alignment to be caught by the tongue (306 in FIG. 3A) of the third section 104 during the initial lift cycle.

FIG. 1B illustrates the configuration of the embodiment of FIG. 1A with the second section 102 having been rotated slightly by the hydraulic pistons 108 in a clockwise direction about the first joint 106, and the third section 104 having been consequently rotated counterclockwise about the second joint 110, a tongue 306 on the third section 104 having been slid thereby into a receiver 404 under the car.

FIG. 1C illustrates the configuration of the embodiment of FIG. 1A with the second section 102 having been rotated by the hydraulic pistons 106 approximately 20 degrees in a clockwise direction, thereby having tilted the third section 104 and the vehicle 112 approximately 40 degrees counterclockwise, while the front wheels of the vehicle 112 remain on grade. Note that the increasing rotation angles about the first and second joints 108, 110 have caused the front of the vehicle 112 to draw closer to the main frame 100.

FIG. 1D illustrates the configuration of the embodiment of FIG. 1A with the second section 102 having been rotated by the hydraulic pistons 106 approximately 30 degrees in a clockwise direction, thereby having tilted the third section 104 and the vehicle 112 approximately 60 degrees counterclockwise. Note that because the third section 104 is shorter than the second section 102, the front of the vehicle 112 has been lifted above grade.

FIG. 1E illustrates the embodiment of FIG. 1A in its fully retracted and stowed configuration, the supported vehicle 112 being configured in a downwardly vertical orientation that requires much less horizontal space than its normal horizontal configuration.

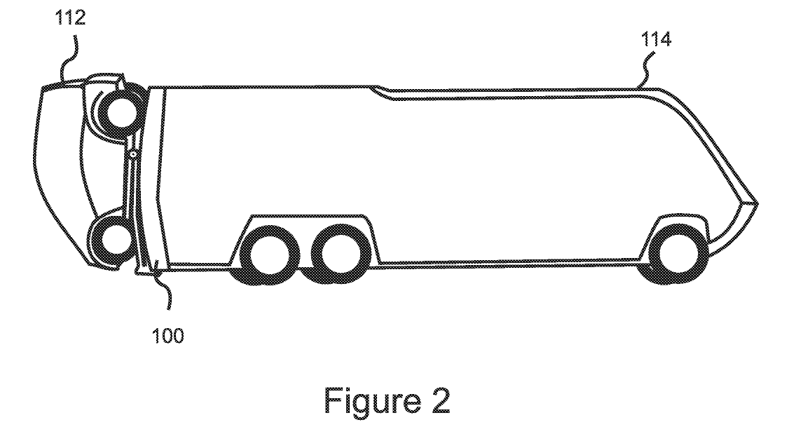

FIGS. 1A through 1E do not indicate whether the main frame 100 is attached to a host vehicle or to a stationary structure. For example, the main frame 100 could be attached to pavement or to some other horizontal supporting surface in these figures, and could be used for storing vehicles 112 compactly in a storage lot. FIG. 2 illustrates the embodiment of FIG. 1E attached to the aft end of a recreational vehicle 200, showing the stowed vehicle 112 compactly stored against the aft end of the recreational vehicle 200.

FIGS. 3A through 3C illustrate the second section 102 and third section 104 of FIGS. 1A through 1E in several configurations without an attached vehicle. FIG. 3A illustrates the embodiment in its fully extended, loading configuration, FIG. 3B illustrates the embodiment in a partially retracted configuration, and FIG. 3C illustrates the embodiment in a fully retracted configuration. The main frame 100 in this embodiment is configured for mounting to the main rails of an RV or truck chassis. Control rods 300 are rotatably connected at a first control pivot point 302 to the main frame 100, lower and further outboard than the first pivot point 106, and at a second control pivot point 304 to the third section 104 at a point outboard of the second pivot point 110. The control rods 300 control the relative motion of the third section 104 with respect to the second section 102 when the VLS is operated. The location of the pivot joints 106, 302 on the main frame 100, and the lengths of the second section 102 and of the control rods 300 that link them to the pivot joints 110, 304 on the third section 104, are configured whereby rotation of the second section 102 into a vertical orientation with respect to the main frame 100 necessarily lifts the third section 104 on an inward arc and rotates it outwardly, so as to bring the third section 104 into a substantially vertical orientation next to and above the main frame 100.

Note that the four pivot joints 106, 302, 110, 304 have displaced but parallel axes, and fixed distances between them. It is the angles between the elements that connect the pivot joints that change. As shown in FIGS. 3A through 3C, there are multiple points of structural support along each axis of rotation 106, 302, 110, 304, providing lateral stability and rigidity to the structure.

In various embodiments, the distal end of the third section 104 is configured with rollers, wheels and/or skid plates (not shown) whereby it rolls or slides along the ground during the final 10 degrees (approximately) of VLS extension and the first 10 to 15 degrees (approximately) of retraction. The distal ends of the control rods 300 are slotted or elongated as shown in the figures so as to accommodate this 10-15 degrees of flexing during extension, whereby the distal end of the third section 104 is able to contact the ground and roll or slide outward as the second section 102 reaches the end of its rotation. Conversely, during retraction and catching of a vehicle by the third section, this flexing provided by elongation in the distal end of the control rod 300 allows the distal end of the third section 104 to be dragged or rolled a few inches along the ground as its proximal end is elevated slightly so the vehicle to be stowed 112 can be driven forward to bring a receiver plate 404 attached to the undercarriage of the vehicle 112 into engagement with a vehicle hook 306 attached to a cross bar 108 on the third section 104, and thereafter to begin the outward rotation of the third section 104, the vehicle 112 still rolling on its front wheels, before compression on the control rods 300 begins to lift the third section 104 and the vehicle 112 off the ground.

In loading, the vehicle 112 in this embodiment is backed over the extended VLS members until it triggers a proximity switch (not shown), which causes the VLS to lift slightly so that the vehicle hook 306 is in close proximity with the undercarriage of the vehicle 112. The vehicle 112 is then driven ahead a few inches until vehicle hook 306 engages the receiver assembly 404 fixed to the undercarriage of the vehicle 112. In various embodiments the VLS can be actuated by pressing a button located on the main frame or in a recreational vehicle to which the main frame is attached, or by using a remote control. In still other embodiments, the VLS is actuated by manually operating a hydraulic lever.

In the embodiment of FIGS. 3A-3C, one press of a button on the control panel of the recreational vehicle extends the VLS. The stowable vehicle 112 is then backed into position astride the extended first and second sections 102, 104 until it actuates a proximity switch. It is then driven forward a few inches until the vehicle hook 306 on the third member engages with the vehicle 112. The driver then exits the secondary vehicle 112, after which a single press of a button retracts the VLS with the secondary vehicle 112 to the stowed position, whereby the VLS and the stowed vehicle 112 are ready for transport.

Elongated holes (not shown) in the distal ends of the control rods 300 retard the lift and pitch changes of the vehicle 112 attached to the third section 104, so that the front wheels of the vehicle 112 remain on the ground until the vehicle 112 is partially rotated, thereby reducing the torque required for the second section 102 to lift the vehicle 112 and for the push rods 300 to change the vehicle's pitch. As shown in FIG. 3C, when the VLS reaches its fully retracted configuration, the elongated holes in the distal ends of the control rods 300 allow the third section 104 to fold completely, and allows latching hooks 310 on the main frame 100 to engage with the distal end of the third section 104 before the vehicle 112 comes to rest in the vertical orientation. Without the slack of the elongated holes, a direct linkage would begin to lift the vehicle 112 at full extension, and would not complete the fold before the vehicle 112 impacted the aft end of the recreational vehicle 114.

In the embodiment of FIGS. 3A-3C, the latching hooks 310 are driven by a separate latching piston 312, and a cam shaft (314 in FIG. 3D). The latching hooks 310 are configured so that they not only capture the distal end of the third section 104, but also help support the weight of the VLS sections 102, 104 and of the attached vehicle 112. The cam shaft 314 also serves as a rotation axel for the control rods 300, but the cam shaft itself 314 only rotates when the cam shaft 314 is in a no-load position and the vehicle 112 is fully supported by the second section 102 held by the main frame 100 in the retracted position. The latching piston 312 is spring loaded to the latch position and the cam shaft 314 goes “over center” so that once it is latched, the system stays latched.

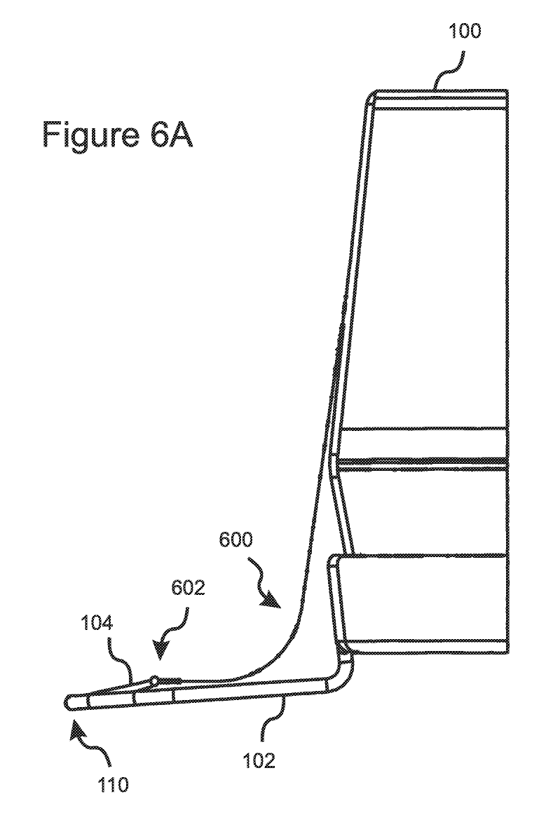

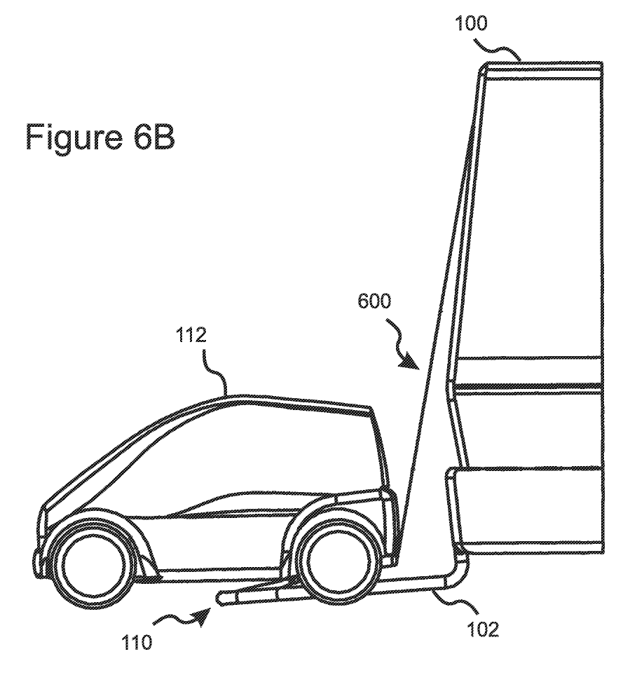

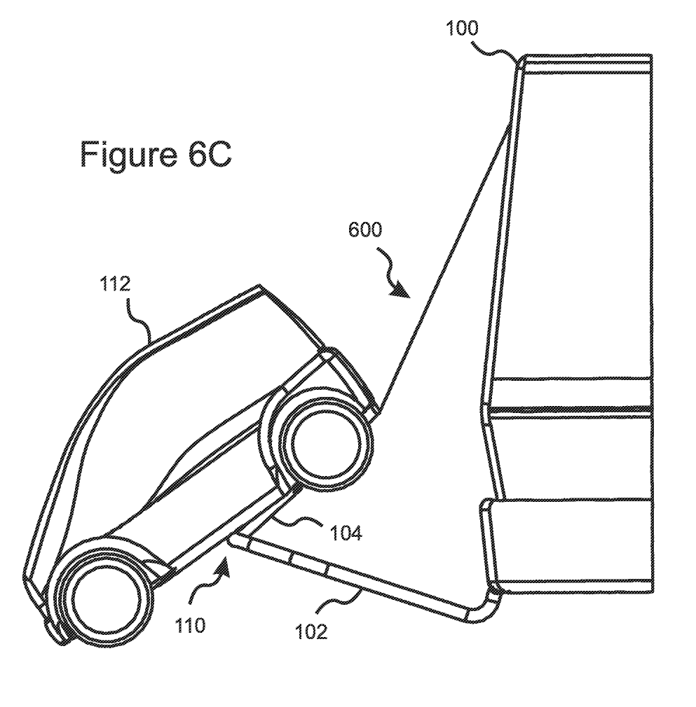

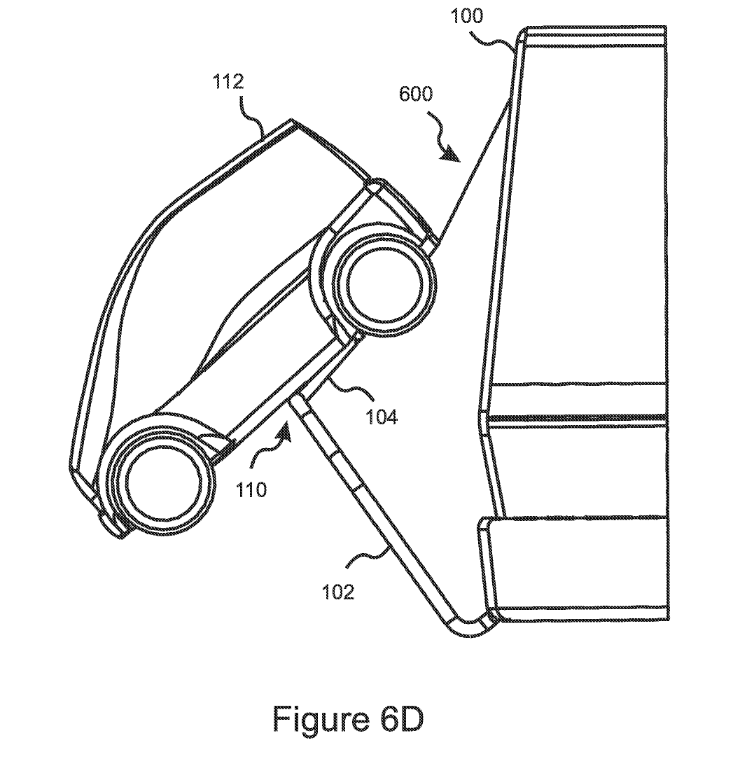

In other embodiments, the power for operating the VLS is delivered by a pull strap, pulling from a varying height on the back of a recreational vehicle 114 or other host vehicle so as to avoid premature and excessive rotating pressure on the stowable vehicle 112 early in the VLS stowing cycle. A pull strap embodiment is discussed in more detail below with reference to FIGS. 6A through 6D.

The embodiment of FIGS. 3A-3C also comprises a large supporting pin assembly 316 incorporated into each side arm of the third section 104. The supporting pin assemblies 316 are extendible into suitable mating holes or recesses incorporated into the underside of the vehicle 112 and aligned with the supporting pin assemblies 316 when the vehicle 112 is properly engaged with the vehicle hook 306. The supporting pin assemblies 316 are configured to be actuated by driving pins (318 in FIG. 3D) from underneath. This occurs while the underside of the third section 104 is being retracted against the driving pins incorporated into a mating trough of the second section 102 which come into contact with the underside of the supporting pin assemblies 316 during retraction of the VLS.

Rotating the vehicle 112 to a nearly full vertical orientation before inserting the support pins 316 assures that the vehicle 112 is fully aligned and supported by the vehicle hook 306 and properly aligned with the supporting pin assembly holes.

In various embodiments, the supporting pin assemblies 316 are two-stage devices that provide for an expansion or other gripping or latching means once the support pins 318 have been inserted into their mating holes 316, thereby ensuring that the vehicle 112 cannot be jarred off of the support pins during transit.

FIG. 3D provides a perspective disassembled view of an array of major and minor components of the embodiment of FIGS. 3A-3C, illustrating their relative structural sizes and shapes.

FIGS. 4A and 4B are perspective views of an attachment cross bar 400 and tapered receiver plate 402, which are sized and configured so as to receive and grip the vehicle hook 306 of FIGS. 3A-3C as the VLS is actuated beneath the properly positioned vehicle 112. The cross bar 400 and receiver plate 402 comprise a receiver assembly 404, mountable to the undercarriage of a vehicle 112 so as to make it compatible with the VLS system of FIG. 3A-3C. The tapered channels of the receiver plate 402 grip the edges of the vehicle hook 306 securely, providing a grip by which the vehicle 112 can be lifted and rotated into the stowed and retracted position.

In loading, the vehicle 112 in this embodiment is backed in over the extended VLS sections 102, 104 until it triggers a proximity switch (not shown), which causes the VLS to lift the second pivot joint 110 into close proximity to the undercarriage of the vehicle 112 (see FIG. 1B). The vehicle 112 is then driven ahead a few inches until the vehicle hook 306 engages the receiver assembly 404 attached to the undercarriage of the vehicle 112. From outside of the vehicle pressing a button on the RV dashboard or on a remote control actuates the VLS so as to lift the car. In this embodiment, one button press extends the VLS, the vehicle 112 is driven into position, and one button press retracts the VLS and stows the vehicle 112.

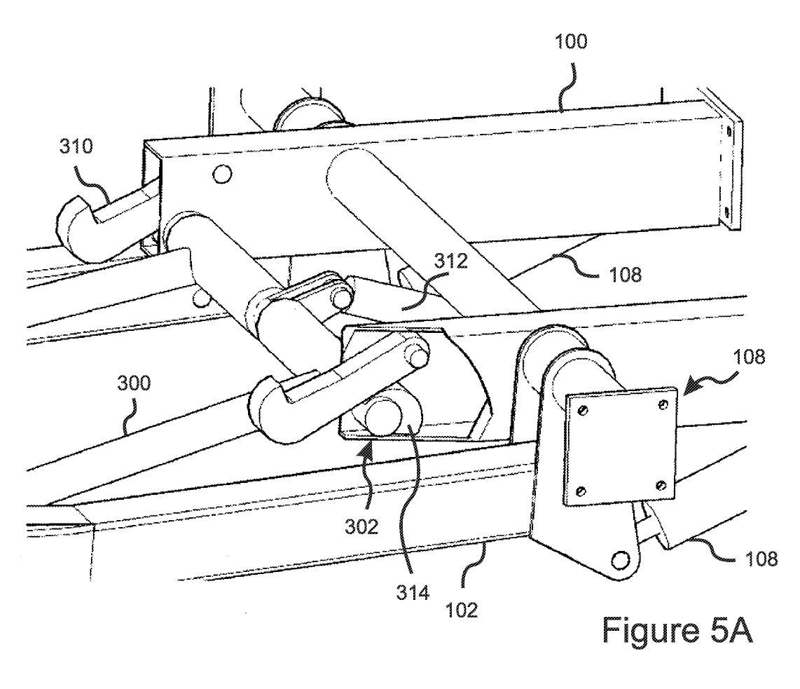

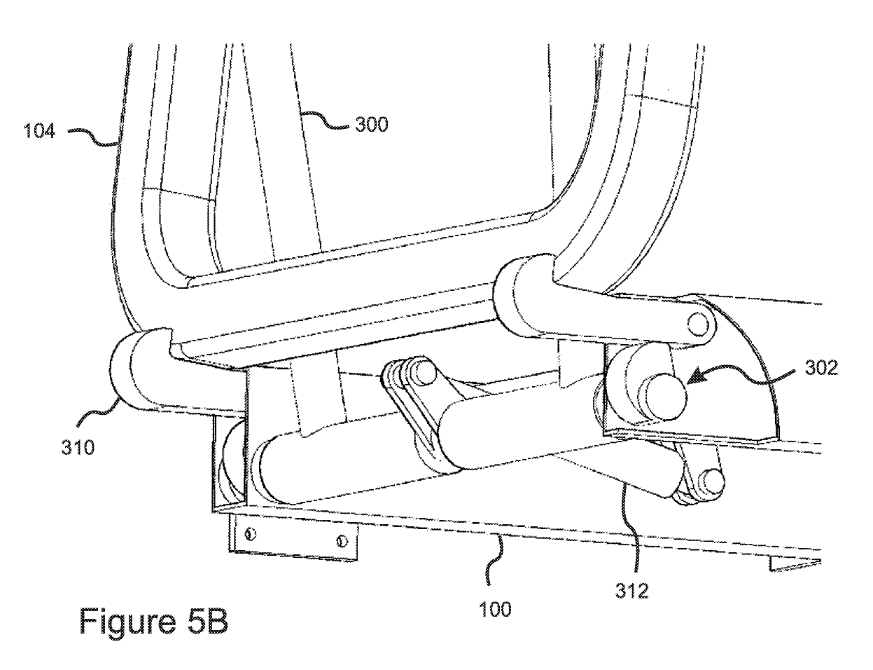

FIGS. 5A and 5B are close-up illustrations of portions of the second and third sections 102, 104 of FIGS. 3A and 3C, showing the hydraulic pistons 108 mounted on the main frame 100, with their distal ends connected to the second section 102 for operating the VLS between its extended and retracted configurations. Also shown in the figures is the piston 312 mounted on the main frame 100 and connected and configured to move the cam shaft 314, which operates the latch hooks 310 that secure the distal end of the third section 104 in the retracted position.

It will be readily apparent that it may be necessary before a vehicle 112 is stowed and/or carried by an embodiment of the present invention to modify some of the fluid reservoirs and possibly the battery of the vehicle 112, so that it can be stowed vertically without disrupting its ability to operate horizontally. The mechanics of the VLS system only require that the vehicle 112 be adapted with a receiver assembly 404 on its undercarriage, suitable for engagement with the third section 104 of the VLS. The vehicle 112 might be driven onto the first and second sections 102, 104 front-end first or rear-end first, and in some embodiments from one side or the other. The engagement mechanism in various embodiments is oriented for approaching the sections 102, 104 from any of the four principle directions, driving towards or away from the main frame 100 or from either side. For example, adapting a so-called “SMART™” car for this purpose only requires adding one accessory and drilling two holes.

The Smart™ car has a steel c-channel type panel ahead of the rear mounted engine that goes across the car between the frame rails under the floor. The panel is bolted to the floor and the side frame rails. The brackets on the frame rails where the panel attaches have an additional threaded hole for something else to attach. Behind the panel, centered in the car, is a bracket that carries the rear suspension and engine. Part of the receiver is an angle iron that bolts to the extra holes in the panel brackets reinforcing the bottom flange of the panel. The rest of the receiver bolts through the plastic belly pan, through the angle, and through two holes drilled in the bottom flange of the panel. The two holes in the vertical plates of the receiver attach to the motor mount bolt in the above mentioned bracket. The reinforcement and attachment of the receiver give it sufficient strength to lift the car.

With reference again to FIGS. 1A through 1E and FIG. 2, in one embodiment whereby a Smart™ car 112 is mounted on the back of a motor home 114, the VLS system works as follows: the car 112 is backed up to the motor home 114 over the third section 104 and second section 102, which just fit between the wheels of the car 112, locating the car 112 laterally over the third section 104 and second section 102. As the car 112 gets close to the motor home 114, it trips a proximity switch, which raises the pivot joint 110 between the third section 104 and the second section 102 slightly. The car 112 then rolls ahead slightly to engage the tongue 306 of the cross bar 308 on the third section with a receiver 404 on the undercarriage of the car 112. The occupants then exit the car 112 and actuate the VLS for retraction.

Even if the car 112 isn't rolled ahead, the tongue 306 will engage the receiver 404 as it lifts. To continue the lifting of the car 112 in this embodiment, an operator must then go to the corner of the motor home 114 and hold a lift button. As the third section 104 and the second section 102 continue to lift, the pivot joint 110 between them lifts up to the car and controls the car's pitch angle of rotation. There are two pins 316 on the third section 104 that engage with two holes in the vehicle frame just behind the front wheels. The holes are about 1″ in diameter, and are provided so as to carry the car 112 through its manufacturing process. The car 112 continues to rise until it is positioned parallel to the rear of the motor home 114. Finally, the car 112 is in place proximate the rear of the motor home and the lift latches into position via latches 310.

With reference to FIG. 6A through 6D, in another embodiment, the second section 102 is lifted with hydraulic cylinders while the third section is controlled by at least one strap or cable 600 that attaches to the third section 104 and thereby to the undercarriage of the car 112 above the hinge of the front bar. A tongue 306 that engages the receiver 404 is attached to the distal end of the third section 104. The car 112 is backed beyond the tongue 306. The second section 102 is rotated upward until the tongue 306 touches the funnel plate 402 of the receiver 404. Then, when the second section 102 continues to lift or the car 112 is driven forward, the tongue 306 is captured by the receiver 404. The cable 600 that actuates the third section 104 runs through the second section 102 from the main frame 100, over a wheel (not shown) and over a half wheel 602 to the proximal end of the third section 104. The half wheel 602 is spring loaded to its shown position. As the third section 104 rotates, the cable 600 engages the half wheel 602, rotating it about half the rotation of the hinge 110. This positions it so that the cable 600 can exert maximum force on the third section 104 through the entire rotation of the hinge 110. The angle between the second extension 102 and the third extension 104 creates a lever above the hinge 110 and holds the cable 600 above the half wheel 602 through half the rotation. Similar embodiments use rods or arms in place of the cable 600 of FIGS. 6A through 6D.

Pins 316 on the third section 104 engage with and latch to holes in the chassis of the car 112. The latching mechanism is optional. The primary function of the pins 316 is to fix the location of the car 112 and carry most of the weight of the car. In some embodiments, the latch has a tapered pin that splays the fixed pin when drawn in. That draw is created by rotating the exocentric at the base of the pin. That rotation can come from a linkage through the hinge 110 to the second extension 102. That latch can be done a number of ways, including an elastic top that mushrooms with the draw of a central rod. It can also be actuated electrically, pneumatically, or hydraulically.

The d pitch of the lift can be adjusted by simply changing the profile of the half round cable guide 602 and/or the hitch point of the cable to the chassis.

The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

What is claimed is:

1. A system for lifting and stowing a stowable vehicle, the system comprising:
a main frame;
a rigid first extension having a first extension proximal end and a first extension distal end, the first extension proximal end being hingedly attached to the main frame so as to enable the first extension to rotate between a substantially horizontal configuration in close proximity to grade and a substantially vertical configuration;
a rigid second extension having a second extension proximal end hingedly attached to the first extension distal end, the second extension being attachable to the stowable vehicle; and
a drive mechanism configured so as to apply a rotational torque to the first extension, thereby transitioning the first extension between the substantially horizontal configuration and the substantially vertical configuration, and transitioning the stowable vehicle between a horizontally deployed configuration on grade and a vertically stowed configuration above grade.

2. The system of claim 1, wherein the main frame is fixable to an immovable support.

3. The system of claim 1, wherein the main frame is mountable to a host vehicle.

4. The system of claim 1, wherein the main frame is mountable to an aft end of a host vehicle, so as to enable vertical stowing of the stowable vehicle above grade and in close proximity to the aft end of the host vehicle.

5. The system of claim 1, wherein the second extension extends horizontally beyond the first extension when the first extension is in the substantially horizontal configuration.

6. The system of claim 5, further comprising a latch configured so as to latch the second extension in vertical proximity to the first extension when the first extension is in the substantially vertical configuration.

7. The system of claim 1, wherein the second extension folds horizontally above and parallel to the first extension when the first extension is in the substantially horizontal configuration.

8. The system of claim 7, further comprising a flexible member extending from the main frame to the second extension and able to apply a pulling force thereto as the first extension is rotated from the substantially horizontal configuration to the substantially vertical configuration.

9. The system of claim 8, further comprising at least one pulley configured so as to support the flexible member and avoid contact between the flexible member and the stowable vehicle.

10. The system of claim 1, wherein the second extension distal end is attachable to at least one of:
the front of the stowable vehicle;
the rear of the stowable vehicle; and
the undercarriage of the stowable vehicle.

11. The system of claim 1, wherein the drive mechanism includes at least one hydraulically driven piston.

12. The system of claim 1, wherein the drive mechanism includes at least one electrically driven motor.

13. The system of claim 1, wherein the drive mechanism can be manually powered.

14. The system of claim 1, wherein the second extension is attachable to the stowable vehicle by insertion of a tongue into a corresponding receptacle.

15. The system of claim 1, further comprising at least one alignment pin attached to the second extension and insertable into an alignment hole provided on the undercarriage of the stowable vehicle so as to at maintain alignment of the stowable vehicle with the second extension.

16. The system of claim 1, further comprising at least one support pin attached to the second extension and insertable into a support hole provided on the undercarriage of the stowable vehicle so as to at least partially support of the weight of the stowable vehicle when the stowable vehicle is in the vertically stowed configuration.

17. The system of claim 16, wherein the support pin includes a pin latching mechanism configured to inhibit unintentional dislodgement of the support pin from the support hole.

18. The system of claim 1, further comprising a switch that is activatable by positioning of the stowable vehicle above the first extension so as to cause the first extension to rotate, bringing the second extension into contact with the undercarriage of the stowable vehicle and thereby causing attachment of the second extension to the stowable vehicle.

19. A system for lifting and stowing a stowable vehicle, the system comprising:
a main frame;
a rigid first extension having a first extension proximal end and a first extension distal end, the first extension proximal end being hingedly attached to the main frame so as to enable the first extension to rotate between a substantially horizontal configuration in close proximity to grade and a substantially vertical configuration;
a rigid second extension having a second extension proximal end hingedly attached to the first extension distal end so as to extend horizontally beyond the first extension in close proximity to grade when the first extension is in the substantially horizontal configuration, the second extension being attachable to the stowable vehicle;
a drive mechanism configured so as to apply a rotational torque to the first extension near the first extension proximal end, thereby transitioning the first extension between the substantially horizontal configuration and the substantially vertical configuration, and consequently transitioning the second extension and the stowable vehicle between a horizontally deployed configuration on grade and a vertically stowed configuration above grade;
a latch configured so as to latch the second extension in vertical proximity to the first extension when the first extension is in the substantially vertical configuration; and
at least one support pin attached to the second extension and insertable into a support hole provided on the undercarriage of the stowable vehicle so as to align the stowable vehicle with the second extension and so as to at least partially support of the weight of the stowable vehicle when the stowable vehicle is in the vertically stowed configuration.

20. The system of claim 19, wherein the main frame is mountable to an aft end of a host vehicle, so as to enable vertical stowing of the stowable vehicle above grade and in close proximity to the aft end of the host vehicle.
